(19) United States
(12) Patent Application Publication
(10) Pub. No.: US 2003/0101347 A1
(43) Pub. Date: May 29, 2003

(54) Method and system to authenticate a user when accessing a service

(76) Inventor: Reed Letsinger, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/996,968

(22) Filed: Nov. 27, 2001

(51) Int. Cl. H04K 1/00

(52) U.S. Cl. 713/182

(57) ABSTRACT

A method and system to authenticate a user accessing a service are disclosed. In one method embodiment, the present invention activates a first communication device to communicate with the service. Further, the present embodiment stores an identifier in a second communications device, wherein the second communications device has a wireless signal strength for transmitting the identifier. Moreover, the present embodiment accesses the service by the first communication device only so long as the first communication device remains within range of the second communication device.

### TECHNICAL FIELD

The present claimed invention relates to the field of mobile electronic devices. More particularly, the present claimed invention relates to the authentication of a user when accessing a service.

### BACKGROUND ART

Presently, due to the explosion of the internet, people are using mobile devices such as portable digital assistants, laptop computers, and cell phones to access services that are running on a server somewhere in a remote location. People are using these remote servers to perform services for them such as online grocery shopping, book purchasing, and making travel arrangements. Further, they are using such services to perform functions for them such as checking the stock markets and accessing personal banking and investment data.

Due to the private content of the services and functions being accessed, the average person has many personal identification codes and passwords. These personal identification codes and passwords are required to access each service or function. In order to keep track of the personal identification codes and passwords needed to access each service or function, many mobile devices are capable of retaining personal identification codes and passwords.

The problem with mobile devices that are capable of retaining personal identification codes and passwords, is the likelihood that this private information will be compromised. Thus, the information is kept private, and remains secure only so long as limits are placed on any mobile device which retains personal or private information. As soon as another user activates the mobile device, the security at the remote server is compromised. Whether or not the other user is authorized to use the mobile device makes little difference. It does not even matter whether the mobile device is borrowed, lost, or stolen. Each password located within the memory of the mobile device is suspect to compromise.

Due to such compromise, upon return of a ‘borrowed’ mobile device all passwords and codes must be changed in order to retain personal privacy and security. Thus, a major disadvantage of this type of system is the time required to remain vigilant about the security of personal identification codes and passwords located on any mobile device.

Another approach to personal privacy and security, while accessing a remote server, would include the user entering a password into a mobile device, upon contact with the remote server. This password would not be retained upon the mobile device and would therefore negate the problems of “borrowing” that could include lending, losing, and stealing the mobile device. However, such an authentication scheme is inconvenient because a person would be required to supply a password or code every time they accessed their remote server. This need to self authenticate with such a service by such a means would become more obtrusive as encounters with the service increased.

A further problem concerning verification, upon each interaction with different services, is the ability to remember a multitude of personal identification codes and passwords. If each service or function requires a different personal identification code or password, recall of the security verification information could require extensive use of obvious names and dates. Such simplified personal identification codes and passwords make unauthorized access into personal accounts much simpler. If a person is limited in their verification means, to information they can retain outside of a mobile device, a second resort may be to write down the personal identification codes and passwords. Once the personal identification codes and passwords are written down they are then subject to loss or theft as well as a anyone finding the stored paper.

Therefore, there exists a need in the prior art for a method and system to authenticate a user accessing a service. A further need exists for a method and system to authenticate a user accessing a service which meets the above need and which retains passwords and codes for a service in a location which is not shared. A further need exists for a method and system to authenticate a user accessing a service which meets the above needs and which relieves a user from having to remember passwords and codes required to access a service.

### DISCLOSURE OF THE INVENTION

The present invention provides, in various embodiments, a method and system to authenticate a user accessing a service. The present invention also provides a method and system to authenticate a user accessing a service which meets the above need and which retains passwords and codes for a service in a location that is not shared. The present invention further provides a method and system to authenticate a user accessing a service which meets the above needs and which relieves a user from having to remember passwords and codes required to access a service.

Specifically, in one method embodiment, the present invention activates a first communication device to communicate with the service. Further, the present embodiment stores an identifier in a second communications device, wherein the second communications device has a wireless signal strength for transmitting the identifier. Moreover, the present embodiment accesses the service by the first communication device only so long as the first communication device remains within range of the second communication device.

These and other advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary communication network in which the exemplary computing system can be used in accordance with one embodiment of the present invention.

FIG. 2 is a block diagram of exemplary circuitry of a computing system in accordance with one embodiment of the present invention.

FIG. 3 is a block diagram of exemplary process of two or more separate computing systems in accordance with one embodiment of the present invention.

FIG. 4 is a flow chart of steps in a method to authenticate a user when accessing a service, in accordance with one embodiment of the present invention.

FIG. 5 is a flow chart of steps in a method to authenticate a user when accessing a service, in accordance with one embodiment of the present invention.

The drawings referred to in this description should be understood as not being drawn to scale except if specifically noted.

### BEST MODES FOR CARRYING OUT THE INVENTION

In the following detailed description of the present invention, a method and system to authenticate a user when accessing a service, specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

Notation and Nomenclature

Some portions of the detailed descriptions that follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those that require physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

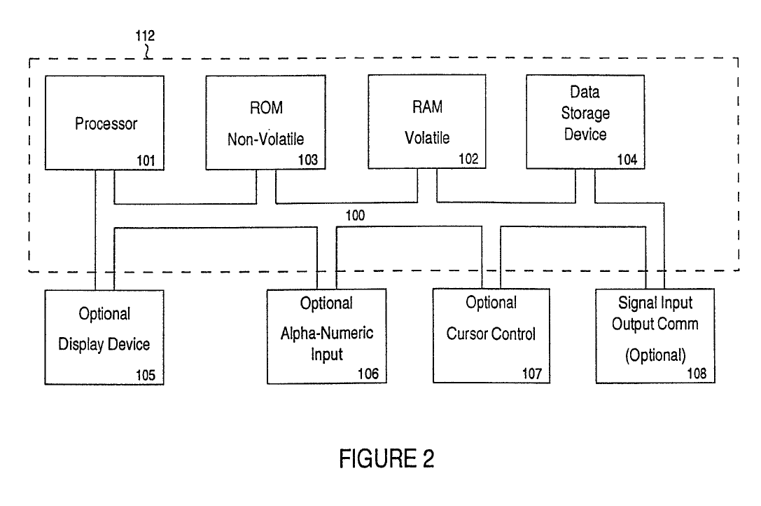

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “activating”, “storing”, “transmitting” “accessing”, or the like, refer to the action and processes of a computer system (e.g., FIG. 2), or similar electronic computing device, that manipulates and transforms data represented as physical (electronic) quantities within the computer system+s registers and memories into other data similarly represented as physical quantities within the computer system memories or registers or other such information storage, transmission or display devices.

Aspects of the present invention, described below, are discussed in terms of steps executed on a computer system. These steps (e.g., processes 400 and 500) are implemented as program code stored in computer readable memory units of computer systems and are executed by the processor of the computer system. Although a variety of different computer systems can be used with the present invention, an exemplary wireless computer system is shown in FIG. 2 below.

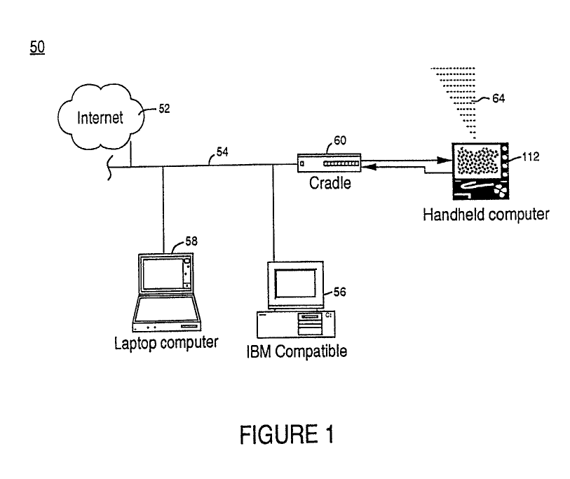

Referring now to FIG. 1, a system 50 that may be used in conjunction with the present invention is shown. It is appreciated that method and system to authenticate a user when accessing a service can be used in conjunction with any computer system and that system 50 is illustrative rather than limiting. It is further appreciated that the portable computer system 112 ( hereafter known as communication device 112) described below is only exemplary. System 50 comprises a host computer system 56 which can either be a desktop unit as shown, or, alternatively, can be a laptop computer system 58. Optionally, one or more host computer systems can be used within system 50. Host computer systems 58 and 56 are shown connected to a communication bus 54, which in one embodiment can be a serial communication bus, but could be of any of a number of well known designs, e.g., a parallel bus, Ethernet, Local Area Network (LAN), etc. Optionally, bus 54 can provide communication with the Internet 52 using a number of well-known protocols.

Importantly, bus 54 is also coupled to a wireless communications device 60 for receiving and initiating communication with communication device 112. Communication device 112 also contains a wireless communication mechanism 64 for sending and receiving information from other devices. The wireless communication mechanism 64 can use infrared communication or other wireless communications such as a Bluetooth protocol.

Referring now to FIG. 2, a block diagram of exemplary communication device 112 is shown. Communications device 112 includes an address/data bus 100 for communicating information, a central processor 101 coupled with bus 100 for processing information and instructions, a volatile memory unit 102 (e.g., random access memory, static RAM, dynamic RAM, etc.) coupled with bus 100 for storing information and instructions for central processor 101 and a non-volatile memory unit 103 (e.g., read only memory, programmable ROM, flash memory, EPROM, EEPROM, etc.) coupled with bus 100 for storing static information and instructions for processor 101. As described above, communication device 112 also includes signal communication interface 108, which is also coupled to bus 100. Communication interface 108 can also include number of wireless communication mechanisms such as infrared or a Bluetooth protocol.

It is appreciated that communication device 112 described herein illustrates an exemplary configuration of an operational platform upon which embodiments of the present invention can be implemented. Nevertheless, other computer systems with differing configurations can also be used in place of communication device 112 within the scope of the present invention.

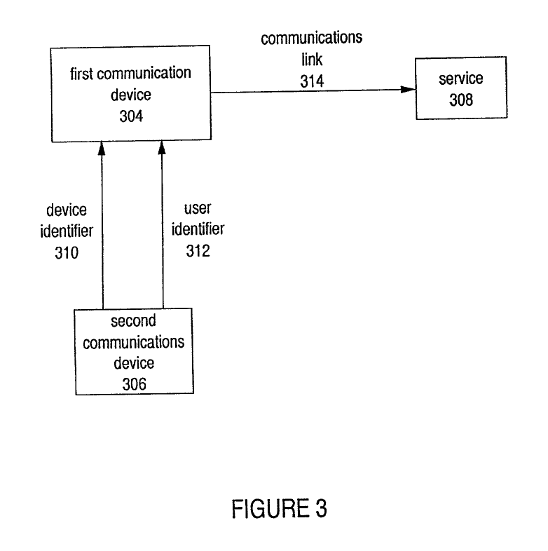

One embodiment of the system is disclosed in FIG. 3. Specifically, as shown in FIG. 3, the present invention can include, but is not limited to, first communication device 304, second communications device 306, and service 308. In one embodiment, second communications device 306 supplies device identification 310 and user identification 312 to first communication device 304. In one embodiment, first communication device 304 and second communications device 306 are mobile devices. Further, in one embodiment, service 308 is a remote computing system. In general, the utilization of second communications device 306 in conjunction with first communication device 304 allows for secure measures to be taken during any interaction between first communication device 304 and service 308. Specifically, the present invention maintains two distinct security measures which ensure that personal security and privacy are maintained between a user utilizing first communication device 304 and a service 308. The afore mentioned security measures include a device identification 310 and user identification 312. Each security measure further maintains an activation distance. Hence, as described below, the present invention discloses a novel way of maintaining personal security and privacy.

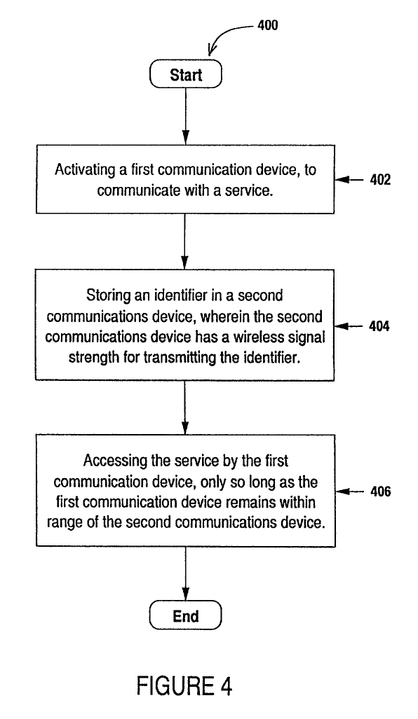

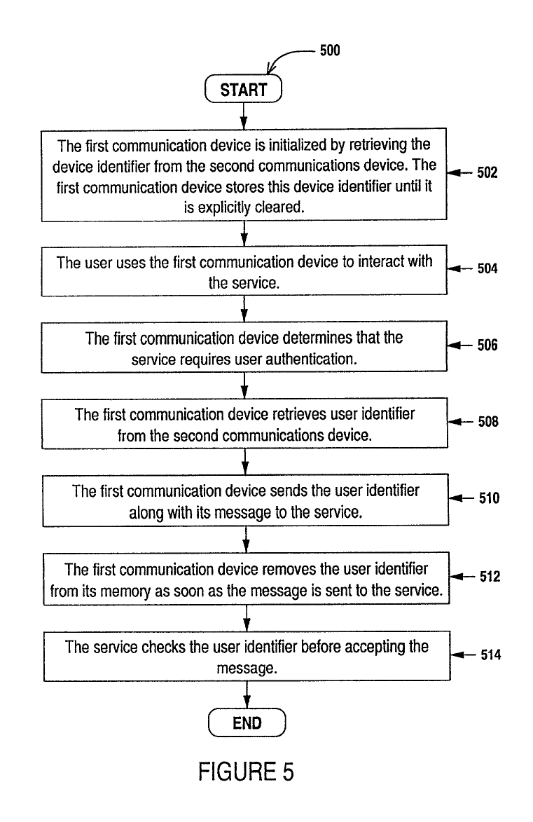

The currently preferred embodiment is described with reference to FIG. 3, FIG. 4, and FIG. 5. With reference now to step 402 of FIG. 4 and to FIG. 3, the present invention activates a first communication device 304, to communicate with service 308. First communication device 304 is a type of communication device 112. In one embodiment, first communication device 304 may be a personal digital assistant. Further, service 308 is a server commensurate to computing system 56. The present invention establishes communications link 314 between first communication device 304 and service 308. Further, communications link 314 is wireless. Although computing system 56 is explicitly mentioned as a server commensurate to service 308, the present invention is well suited to the use of computing system 58 or any other separate computing system within the scope of the present invention as a server commensurate to service 308.

With reference now to step 404 of FIG. 4 and to FIG. 3, the present invention stores an identifier in a second communications device 306, wherein the second communications device 306 has a wireless signal strength for transmitting the identifier. In one embodiment, second communications device 306 can be worn by the user. In another embodiment, second communications device 306 can be carried by the user. Specifically, second communications device 306 is small enough to be carried in a wallet.

With reference still to step 404 of FIG. 4 and to FIG. 3, second communications device 306 is a type of communication device 112. Although second communications device 306 is explicitly recited in the proposed embodiment as a type of communication device 112, the present invention is well suited to a second communications device 306 which comprises a data storage device 104, bus 100, and communications interface 108. Further, it is evident that many alternatives, modifications, permutations and variations to second communications device 306 will become apparent to those skilled in the art.

With further reference to step 404 of FIG. 4 and to FIG. 3, second communications device 306 contains device identifier 310. Device identifier 310 is required by first communication device 304. Specifically, device identifier 310 is required to initialize first communication device 304.

With reference still to step 404 of FIG. 4 and to FIG. 3, first communication device 304 can store only one device identifier 310. Further, first communication device 304 requires a location proximal to second communications device 306 in order to receive device identifier 310. For example, first communication device 304 receives device identifier 310 from second communications device 306 via intimate contact. Although intimate contact is explicitly mentioned, the present invention is well suited to the use of other types of proximal transfer of device identifier 310. As described above, first communication device 304 receives device identifier 310 from second communications device 306 via intimate contact. Of particular significance is the range of second communications device 306 with regard to first communication device 304 during the reception of device identifier 310. Specifically, since intimate contact is required, the obvious act of a first communication device 304 receiving device identifier 310 will not go unnoticed. Therefore, it is extremely difficult for any first communication device 304 to illicitly obtain specific device identifier 310 from second communications device 306.

With reference now to step 406 of FIG. 4 and to FIG. 3, the present invention accesses service 308 by first communication device 304, only so long as first communication device 304 remains within range of second communications device 308. Additionally, first communication device 304 accesses service 308 using internet 52 protocol. Although first communication device 304 accesses service 308 using internet 52 protocol, the present invention is well suited to many first communication device 304 accessing options which would be obvious to one skilled in the art but which have not been described in detail as not to unnecessarily obscure aspects of the present invention.

With further reference to step 406 of FIG. 4 and to FIG. 3, second communications device 306 provides user identifier 312 to first communication device 304 only upon initial access to service 308. In another embodiment, second communications device 306 provides user identifier 312 to first communication device 304 intermittently upon access to service 308. In yet another embodiment, second communications device 306 provides user identifier 312 to first communication device 304 constantly upon access to service 308.

With reference still to step 406 of FIG. 4 and to FIG. 3, the transfer of user identifier 312 from second communications device 306 to first communication device 304 takes place wirelessly. Specifically, the transfer of user identifier 312 takes place wirelessly using communication mechanism 64. The wireless communication mechanism 64 can use infrared communication or other wireless communications such as a Bluetooth protocol.

With further reference to step 406 of FIG. 4 and to FIG. 3, second communications device 306 has a reduced wireless signal strength. Specifically, second communications device 306 has a range of one meter. Although a range of one meter is explicitly recited in the proposed embodiment, the present invention is well suited to the use of various other signal strengths.

With reference still to step 406 of FIG. 4 and to FIG. 3, whenever first communication device 304 moves out of range of second communications device 306, first communication device 304 can no longer maintain user identifier 312. Specifically, whenever first communication device 304 moves out of range of second communications device 306, first communication device 304 must re-acquire user identifier 312 from second communications device 306. The purpose of the limited range of second communications device 306 is the second major security feature of the present invention. For example, if a different first communication device 304 illicitly obtained device identifier 310, then different first communication device 304 must remain within the limited range of second communications device 306 in order to utilize user identifier 312 to access service 308. As soon as different first communication device 304 moved out of range, all access to service 308 would be lost. Therefore, personal security and privacy is further maintained.

One embodiment of the system is disclosed in FIG. 5. Specifically, as shown in FIG. 5, an example embodiment of the present invention, as exhibited in FIG. 3, is outlined. In one embodiment of the present invention, first communication device 304 is initialized by retrieving device identifier 310 from second communications device 306. In so doing, first communication device 304 stores device identifier 310 until is explicitly cleared. Once first communication device 304 is initialized, the user then uses first communication device 304 to interact with service 308. Upon interaction with service 308, first communication device 304 determines that service 308 requires user authentication. Accordingly, first communication device 304 retrieves user identifier 312 from second communications device 306 and sends both user identifier 312 and the message to service 308. Upon successful communication and verification with service 308, first communication device 304 removes user identifier 312 from its memory. Although this example outlines a specific embodiment of the present invention, the above mentioned embodiment is outlined for purposes of clarity not limitation.

Thus, the present invention provides, in various embodiments, a method and system to authenticate a user accessing a service. The present invention also provides a method and system to authenticate a user accessing a service which meets the above need and which retains passwords and codes for a service in a location that is not shared. The present invention further provides a method and system to authenticate a user accessing a service which meets the above needs and which relieves a user from having to remember passwords and codes required to access a service.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

What is claimed is:

1. A method to authenticate a user accessing a service, said method comprising:
activating a first communication device, to communicate with said service;
storing an identifier in a second communications device, wherein said second communications device has a wireless signal strength for transmitting said identifier; and
accessing said service by said first communication device, only so long as said first communication device remains within range of said second communications device.

2. The method as recited in claim 1, wherein said first communication device requires a device identifier from said second communications device.

3. The method as recited in claim 2, wherein said first communication device requires a location proximal to said second communications device in order to receive said device identifier.

4. The method as recited in claim 2, wherein said first communication device can store only one said device identifier at a time.

5. The method as recited in claim 1, wherein said second communications device has a reduced said wireless signal strength.

6. The method as recited in claim 1, wherein said second communications device provides a user identification to said first communication device.

7. The method as recited in claim 6, wherein said second communications device provides said user identification to said first communication device only upon initial access to said service by said first communication device.

8. The method as recited in claim 6, wherein said second communications device provides said user identification to said first communication device intermittently upon access to said service by said first communication device.

9. The method as recited in claim 6, wherein said second communications device provides said user identification to said first communication device constantly upon access to said service by said first communication device.

10. A user authentication system comprising:
a first communication device;
a second communications device having a signal strength for wirelessly transmitting an identifier stored within said second communications device; and
a service which performs functions according to the user, wherein said service only performs said functions so long as said first communication device remains within range of said signal strength of said second communications device.

11. The system as recited in claim 10, wherein said first communication device requires a device identifier from said second communications device.

12. The system as recited in claim 11, wherein said first communication device requires a location proximal to said second communications device in order to receive said device identifier.

13. The system as recited in claim 11, wherein said first communication device can store only one said device identifier at a time.

14. The system as recited in claim 10, wherein said second communications device has a reduced said wireless signal strength.

15. The system as recited in claim 10, wherein said second communications device can be worn.

16. The system as recited in claim 10, wherein said second communications device can be carried in a wallet.

17. The system as recited in claim 10, wherein said second communications device has a reduced said wireless signal strength.

18. The system as recited in claim 10, wherein said second communications device provides a user identification to said first communication device.

19. The system as recited in claim 18, wherein said second communications device provides said user identification to said first communication device only upon initial access to said service by said first communication device.

20. The system as recited in claim 18, wherein said second communications device provides said user identification to said first communication device intermittently upon access to said service by said first communication device.

21. The system as recited in claim 18, wherein said second communications device provides said user identification to said first communication device constantly upon access to said service by said first communication device.
